(19) United States
(12) Patent Application Publication
(10) Pub. No.: US 2026/0310055 A1
(43) Pub. Date: Oct. 8, 2026

(54) LASER REFLECTION UNIT

(71) Applicant: BARCO N.V., Kortrijk (BE)

(72) Inventor: Wouter JANSSENS, Sint-Andries (BE)

(73) Assignee: BARCO N.V., Kortrijk (BE)

(21) Appl. No.: 19/481,761

(22) PCT Filed: May 8, 2024
(86) PCT No.: PCT/EP2024/062691

§ 371 Date: Nov. 5, 2025

(30) Foreign Application Priority Data
May 9, 2023 (LU) 103118

(51) Int. Cl. G03B 21/16; G03B 21/14; G03B 21/20

(52) U.S. Cl. CPC G03B 21/16; G03B 21/145; G03B 21/204; G03B 21/2066

(57) ABSTRACT

A laser reflection includes a housing and a wheel. The housing having a top portion and a bottom portion mechanically fastened to the top portion. The top portion and the bottom portion correspondingly having stationary vanes. The stationary vanes are arranged spirally. The wheel is arranged within the housing and has cooling fins. The cooling fins and the stationary vanes have a same central axis.

### TECHNICAL FIELD

The present disclosure relates to a laser reflection unit, in particular to a laser reflection unit having a housing and stationary vanes arranged within the housing.

### BACKGROUND

Laser phosphor projectors include a laser reflection unit that converts high intensity laser light into coloured light for use in illumination optics of said laser phosphor projector. When transforming the light, some of the energy gets lost and is transformed into heat absorbed by the phosphor layer applied directly on a wheel in the laser reflection unit. The heat transmits into the wheel and the temperature rises. To keep the temperature in the wheel on a safe level, the heat needs to be distributed at lower intensity to the cooler surroundings.

In conventional solutions cold air is blown directly on the phosphor wheel itself by a fan inside the unit making a circulation towards the heated phosphor wheel and push the air to cooled surfaces inside the unit. The hot air needs to be guided to be cooled inside the unit by a heat exchanger made of heat pipe technology or large air-cooled areas in contact with the surrounding cooler regions. The conventional solution is typically large, heavy and complex.

There is therefore a need for improvement in the art.

### SUMMARY

The present disclosure provides a laser reflection unit and a method of operating thereof. The laser reflection unit comprises a housing and a wheel. The housing having a top portion and a bottom portion mechanically fastened to the top portion. The top portion and the bottom portion correspondingly having stationary vanes. The stationary vanes are arranged spirally. The wheel is arranged within the housing and has cooling fins. The cooling fins and the stationary vanes have a same central axis.

Accordingly, one aspect of the instant disclosure provides a laser reflection unit for a laser phosphor projector that comprises a housing having a top portion and a bottom portion mechanically fastened to the top portion, the top portion and the bottom portion correspondingly having stationary vanes provided on the inside wall of the housing, the stationary vanes being spirally arranged around a central axis of the laser reflection unit; the housing further having lateral walls extending from the top portion to the bottom portion and a wheel arranged within the housing and having a top side and a bottom side opposite the top side, the top side being provided with a phosphor layer arranged annularly on the top side for converting an incident laser light beam into a reflected light beam, the bottom side being provided with cooling fins, wherein the wheel is rotatably received in the top portion of the housing such that the cooling fins are arranged to be encompassed by the stationary vanes of the top portion and is configured to rotate around the central axis, and wherein the stationary vanes of the top portion are configured to receive from a same plane an air flow generated by the cooling fins of the wheel upon rotation of the wheel, and spirally guide the air flow outwards towards the lateral walls of the housing, and then downwards along the lateral walls towards the stationary vanes of the bottom portion, the stationary vanes of the bottom portion being configured to spirally guide the air flow inwards towards the centre of the bottom portion and upwards via the centre to the cooling fins of the wheel such that the airflow cools the phosphor layer.

The stationary vanes in the housing are spirally arranged around the central axis, which creates a spiral path for the air flow generated by the cooling fins of the wheel. The spiral movement of the air flow helps to evenly distribute the cooling effect around the annular phosphor layer on the top side of the wheel.

In some embodiments, a number of the stationary vanes of the bottom portion of the housing is a multiple of a number of the stationary vanes of the top portion of the housing.

In some embodiments, a spiral direction of the stationary vanes of the bottom portion of the housing is opposite of a spiral direction of the stationary vanes of the top portion of the housing.

In some embodiments, channels between the stationary vanes are formed of a same width.

In some embodiments, channels formed by at least one stationary vane of the top portion have a same width.

In some embodiments, the bottom portion further comprises a base and an outer rim surrounding the base. The top portion further comprises a lid and an outer rim surrounding the lid. And the stationary vanes of the top portion are affixed to the lid and the outer rim of the top portion, and the stationary vanes of the bottom portion are affixed to the base and the outer rim of the bottom portion.

In some embodiments, the laser reflection unit further comprises fluid ports between the base and a cover of the bottom portion to form a compartment for receiving cooling fluid. Protrusions are formed on an outer surface of the base to distribute the cooling fluid going throughout the outer surface and increase heat exchanging surface between the base and the cooling fluid within the compartment.

In some embodiments, the laser reflection unit further comprises a seal formed to fill a space between the outer surface of the base and the cover.

In some embodiments, the lid and the outer rim formed a curved surface configured to direct air flow from the top portion to the bottom portion of the housing.

In some embodiments, the cooling fins have backward curve arrangement, forward curve arrangement, or radial arrangement.

In some embodiments, the top side is perforated to form perforations allowing air flow towards the top side of the wheel. And a motor is configured to drive rotation of the wheel.

In some embodiments, pins are formed on the stationary vanes.

In some embodiments, the stationary vanes of the top portion and the bottom portion such the stationary vanes remain in a same arrangement when radial alignment between the top portion and the bottom portion shifts at an angle.

In some embodiments, the angle may be determined according to a greatest common divisor (GCD) between a number of the stationary vanes of the top portion and a number of the stationary vanes of the bottom portion.

In some embodiments, the cooling fins is configured to adjust pressure and velocity of air circulating within the laser reflection unit.

In some embodiments, the top portion has a compartment on the central portion surrounded by the stationary vanes on the top portion to receive the wheel. The diameter of the wheel is less than the diameter of the compartment in the top portion.

Accordingly, another aspect of the instant disclosure provides a laser reflection unit of a laser phosphor projector that comprises a housing having a top portion and a bottom portion mechanically fastened to the top portion, the top portion and the bottom portion correspondingly having stationary vanes, the stationary vanes forming spiral channels; and a wheel disposed within the housing and configured to generate air flow in a direction tangential to the circumference of the wheel. The wheel has a phosphor layer arranged annularly on a top side of the wheel. The stationary vanes of the top portion form a compartment to receive the wheel. Air flow generated by the wheel flows within a path formed by the channels. The air flow from the channels of the stationary vanes of the bottom portion (3) is driven in rotational flow towards the wheel.

In some embodiments, the stationary vanes of the bottom portion forms a multiple arm Archimedean spiral pattern; and/or the stationary vanes of the top portion of the housing form a single arm or a multiple arm Archimedean spiral pattern.

This arrangement offers a longer airflow path, thereby increasing heat exchange surface area. Additionally, the Archimedean spiral configuration provides a consistent path width, reducing kinetic energy loss caused by airflow path width fluctuations and gradual flow direction changes.

In some embodiments, a number of the stationary vanes of the bottom portion of the housing is a multiple of a number of the stationary vanes of the top portion of the housing.

In some embodiments, a spiral direction of the stationary vanes of the bottom portion of the housing is opposite of a spiral direction of the stationary vanes of the top portion of the housing.

In some embodiments, the channels formed by the stationary vanes are formed of a same width.

In some embodiments, the cooling fins have backward curve arrangement, forward curve arrangement, or radial arrangement.

In some embodiments, the bottom portion further comprises a base and an outer rim surrounding the base; the top portion further comprises a lid and an outer rim surrounding the lid; and the stationary vanes of the top portion are affixed to the lid and the outer rim of the top portion and the stationary vanes of the bottom portion are affixed to the base and the outer rim of the bottom portion.

In some embodiments, the laser reflection unit further comprises fluid ports between the base and a cover of the bottom portion to form a compartment for receiving cooling fluid. Protrusions are formed on an outer surface of the base to distribute the cooling fluid going throughout the outer surface and increase heat exchanging surface between the base and the cooling fluid within the compartment.

In some embodiments, the laser reflection unit further comprises a seal formed to fill a space between the outer surface of the base and the cover.

In some embodiments, the lid and the outer rim form a curved surface configured to direct air flow from the top portion to the bottom portion of the housing.

In some embodiments, pins are formed on the stationary vanes.

In some embodiments, the top side is perforated to form perforations allowing air flow towards the top side of the wheel. And a motor is configured to drive rotation of the wheel.

In some embodiments, stationary vanes of the top portion and the bottom portion are arranged such that the stationary vanes remain in a same arrangement when radial alignment between the top portion and the bottom portion shifts at an angle.

In some embodiments, the angle may be determined according to greatest common divisor (GCD) between a number of the stationary vanes of the top portion and a number of the stationary vanes of the bottom portion.

In some embodiments, the cooling fins is configured to adjust pressure and velocity of air circulating within the laser reflection unit.

In some embodiments, the top portion has a compartment on the central portion surrounded by the stationary vanes on the top portion to receive the wheel. The diameter of the wheel is less than the diameter of the compartment in the top portion.

Accordingly, another aspect of the instant disclosure provides a method of operating a laser reflection unit that comprises: rotating a wheel disposed within a housing, the wheel having cooling fins configured to generate air flow during rotation; directing the air flow in a direction towards an outer rim of a top portion of the housing through at least one channel formed by at least one stationary vane of the top portion; directing the air flow in a direction towards channels formed the stationary vanes of the bottom portion; directing the air flow in a direction towards a center of the bottom portion through the channels formed the stationary vanes of the bottom portion; and directing the air flow in a direction towards a center of the wheel from the center of the bottom portion. A low pressure is generated between the cooling fins to drive the airflow back to the wheel.

In some embodiments, the air flow generated by the wheel are generated to flow in a direction tangential to the circumference of the wheel.

In some embodiments, the cooling fins have backward curve arrangement, forward curve arrangement, or radial arrangement.

In some embodiments, the method of operating a laser reflection unit further comprises directing the air flow towards a top side of the wheel through perforations. In some embodiments, the method of operating a laser reflection unit further comprises fastening the top portion and the bottom portion to form a sealed compartment. The stationary vanes of the top portion and the bottom portion such the stationary vanes remain in a same arrangement when radial alignment between the top portion and the bottom portion during fastening shifts at an angle.

In some embodiments, the method of operating a laser reflection unit further comprises determining the angle according to greatest common divisor (GCD) between a number of the stationary vanes of the top portion and a number of the stationary vanes of the bottom portion.

In some embodiments, the stationary vanes of the bottom portion forms a multiple arm Archimedean spiral pattern; and/or the at least one stationary vane of the top portion of the housing form a single arm or a multiple arm Archimedean spiral pattern.

In some embodiments, a number of the stationary vanes of the bottom portion of the housing is a multiple of a number of the at least one stationary vane of the top portion of the housing.

In some embodiments, a spiral direction of the stationary vanes of the bottom portion of the housing is opposite of a spiral direction of the stationary vanes of the top portion of the housing.

In some embodiments, the channels formed by the stationary vanes are formed of a same width.

In some embodiments, the method of operating a laser reflection unit further comprises providing, by a fluid port, a cooling fluid between a base and a cover of the bottom portion; and agitating the cooling fluid using protrusions formed on an outer surface of the base to distribute the cooling fluid going throughout the outer surface and increase heat exchanging surface between the base and the cooling fluid within a compartment formed by the base and the cover.

In some embodiments, the cooling fins is configured to adjust pressure and velocity of the air flow circulating within the laser reflection unit.

It is to be understood that both the foregoing general description and the following detailed description are exemplary and are intended to provide further explanation of the invention as claimed. Other advantages and features of the invention will be apparent from the following description, drawings and claims.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1 illustrates a vertical cross-sectional view of a laser reflection unit according to some embodiments of the present disclosure;

FIG. 2 illustrates a perspective view of a wheel of the laser reflection unit according to some embodiments of the present disclosure;

FIG. 3 illustrates a perspective view of a top portion of a housing of the laser reflection unit according to some embodiments of the present disclosure;

FIG. 4a illustrates a top view of a bottom portion of a housing of the laser reflection unit according to some embodiments of the present disclosure;

FIG. 4b illustrates a bottom view of a bottom portion of a housing of the laser reflection unit according to some embodiments of the present disclosure;

FIG. 5 illustrates a horizontal cross-sectional view of a top portion of a housing and a wheel of the laser reflection unit according to some embodiments of the present disclosure;

FIG. 6 illustrates a schematic exploded view of the laser reflection unit according to some embodiments of the present disclosure; and

FIGS. 7a and 7b show perspective views of a wheel of the laser reflection unit according to some other embodiments of the present disclosure.

### DESCRIPTION OF EMBODIMENTS

The present disclosure will now be described more fully hereinafter with reference to the accompanying drawings, in which exemplary embodiments of the disclosure are shown. This disclosure may, however, be embodied in many different forms and should not be construed as limited to the exemplary embodiments set forth herein. Rather, these exemplary embodiments are provided so that this disclosure will be thorough and complete, and will fully convey the scope of the disclosure to those skilled in the art. Like reference numerals refer to like elements throughout.

The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “comprises” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

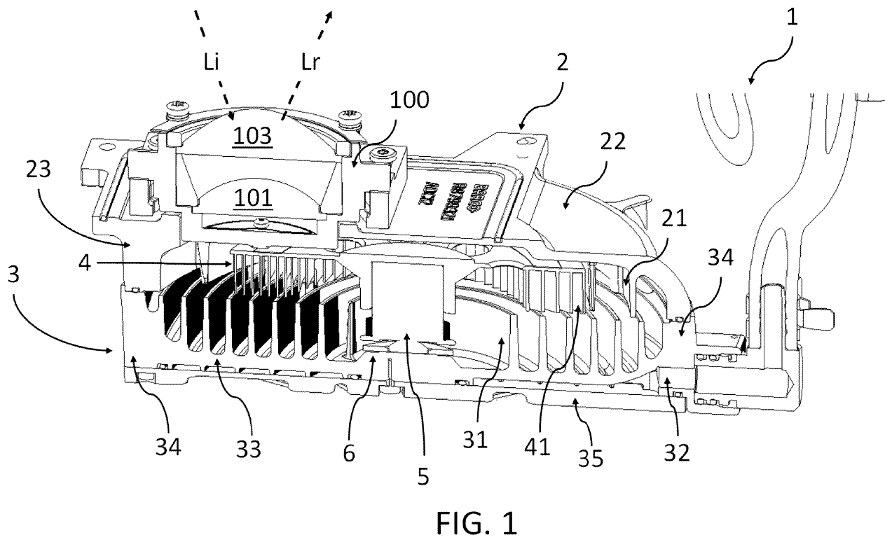

FIG. 1 illustrates a vertical cross-sectional view of a laser reflection unit 1 according to the present disclosure. The laser reflection unit 1 can be applied in a laser phosphor projector for converting high intensity blue laser light into colored light.

The laser reflection unit 1 is provided with a housing and a wheel 4 disposed in the housing. The housing comprises a top portion 2 and a bottom portion 3. In some embodiments, the top portion 2 and the bottom portion 3 may be physically separated from each other for inspection and/or reparability purposes. In further embodiments, the housing may include further number of portions. The top portion 2 and the bottom portion 3 may be coupled to each other using fastening elements. In some embodiments, the fastening elements may be screws or clamping elements. The housing forms a compartment for receiving therein the wheel 4 and heat exchangers described below. The wheel is configured to rotate within the interior compartment or chamber of the housing. The housing is further configured to prevent dust from entering the chamber.

The lid 22 of top portion 2 is perforated to form an opening 99 and a fitting 100 is provided into the opening 99. The fitting 100 is configured to receive an optical assembly. The optical assembly may comprise a first lens 101 and a second lens 103 configured to direct the light on the phosphor layer. The second lens 103 can be disposed above first lens 101.

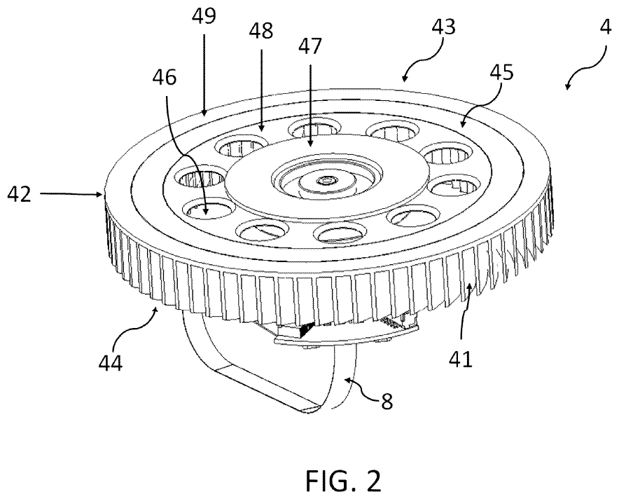

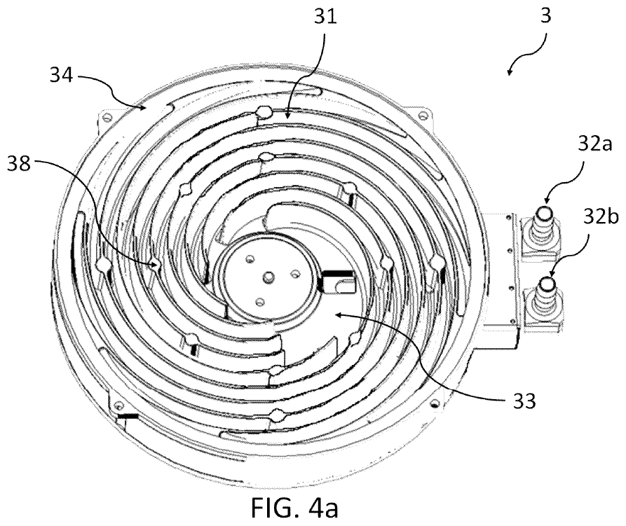

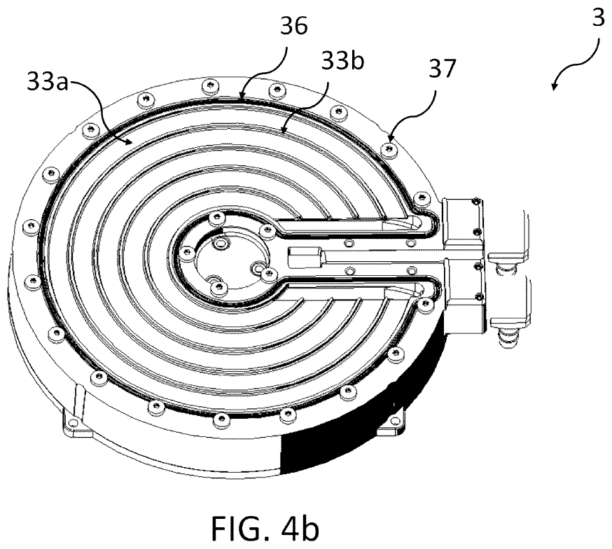

FIG. 2 illustrates a perspective view of the wheel 4 of the laser reflection unit 1 according to some embodiments of the present disclosure. The wheel 4 arranged in the chamber may be driven to rotate by means of an actuator. In some embodiments, the actuator may be a type of motor. The laser reflection unit 1 may further comprise a motor 5 arranged to drive the rotation of the wheel 4 within the housing. The motor 5 is disposed on a central portion of the bottom portion 4 of the housing using fastening elements. In some embodiments, the central portion may have a machined plane surface 6. The laser reflection unit 1 comprises a power cable 8 as shown in FIG. 4 to supply electric power to the wheel motor 5.

As shown in FIG. 2, the wheel 4 has a circular outer peripheral contour 42. The wheel 4 has a top side 43 and a bottom side 44 opposite to the top side 43. The top side 43 is preferably provided with a phosphor layer 45 for converting an incident laser light beam into a reflected light beam. The wheel 4 may further comprise a number of concentric portions, such as a radial central portion 47, a radial intermediate annular portion 48 and a radial outer annular portion 49. The radial outer annular portion 49 adjoins the outer peripheral contour 42 of the wheel 4. The radial intermediate annular portion 48 is disposed between the radial central portion 47 and the radial outer annular portion 49.

During operation of the laser reflection unit 1 the wheel 4 rotates and reflects an incident laser light beam Li entering through the optical assembly, which may comprise the second lens 103 and the first lens 101, and the opening 99 towards the phosphor layer 45 on the wheel 4. Then, the incident beam reflects via the phosphor layer 45 as a reflected light beam Lr propagating outwardly through the opening 99, and the optical assembly. Typically, the incident beam Li may be blue laser light, while the reflected beam Lr may be white light. However, other beam characteristics are applicable, e.g., having other spectral characteristics. Further, another lens construction may be applied, e.g., including other mounting elements and/or less or more than two lenses. Preferably, the optical assembly, or more particularly the lenses 101, 103 are sealed so as to form a dust sealed compartment or chamber inside the housing.

The phosphor layer 45 is provided on the top side 43 of the radial outer annular portion 49. The radial intermediate annular portion 48 preferably has a plurality of perforations 46 evenly and annularly distributed allowing air to flow towards the top side 43 of the wheel 4. Further, the bottom side 44 of the radial central portion 47 of the wheel 4 is mounted on a driving part of the motor 5. In some other embodiments, the configurations of the wheel could be applied, e.g., by including more radial annular portions or by mounting the top side 43 of the wheel 4 to a motor that rotatably drives the wheel 4.

The bottom side 44 of the wheel 4 is provided with cooling fins 41 shaped as radial fan fins generating a local overpressure to induce an air flow flowing in a radial outward direction. The wheel 4 operates both as a fan and a heatsink. The cooling fins 41 may be configured to have backward curve, forward curve, or radial arrangement. In other words, the cooling fins 41 may be curved in the direction of the rotation of the wheel 4, against the direction of the rotation of the wheel 4, or extend straight out from the center of the wheel 4.

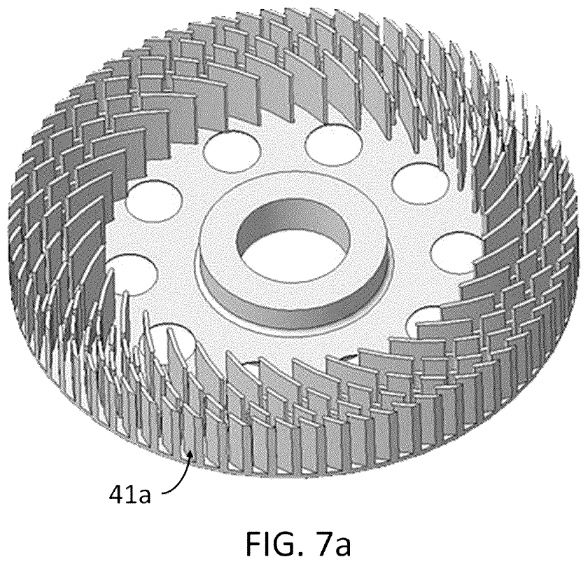

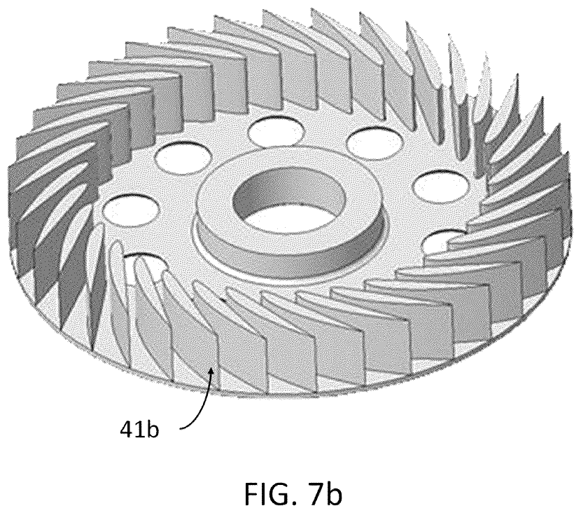

In some other embodiments, the cooling fins may be configured to have different configurations. In an exemplary embodiment, as shown in FIG. 7a, the cooling fins 41a of the wheel 4b may be arranged in a similar way to what has been described above. However, to increase the cooling performance, the cooling fins 41a may further be segmented into a plurality of segments such that there is a space between two adjacent segments of a fin. The space between two adjacent segments of a cooling fin 41a allows the boundary layer of the cooling air to be broken up. In this way, the transfer of heat from the segmented fins to the air is increased by having more exchange of momentum and thermal energy between adjacent fluid particles.

In an exemplary embodiment, as shown in FIG. 7b, the cooling fins 41b of the wheel 4b may be configured to have a profile shape similar to an airfoil. The airfoil shape provides lift effect to the cooling air, increasing velocity and heat transfer.

Thus, in addition to the arrangement of the cooling fins, the shape of the cooling fins further increase the cooling performance of the wheel. The change in the shape of the cooling fins is configured to adjust the pressure and velocity of the cooling air.

When converting the incident laser beam Li into the reflected beam Lr, some of the optical energy is lost and transformed into heat absorbed in the phosphor layer 45 and applied on the top side 43 of the wheel 4. The heat transmits into the wheel material and dissipates through the bottom side 44 of the wheel 4. The air generated by the cooling fins 41 on the bottom side 44 of the wheel 4 during rotation flows outwards to the outer peripheral contour 42 of the wheel 4. Heat from the wheel 4 dissipates through the air by convection between the cooling fins 41.

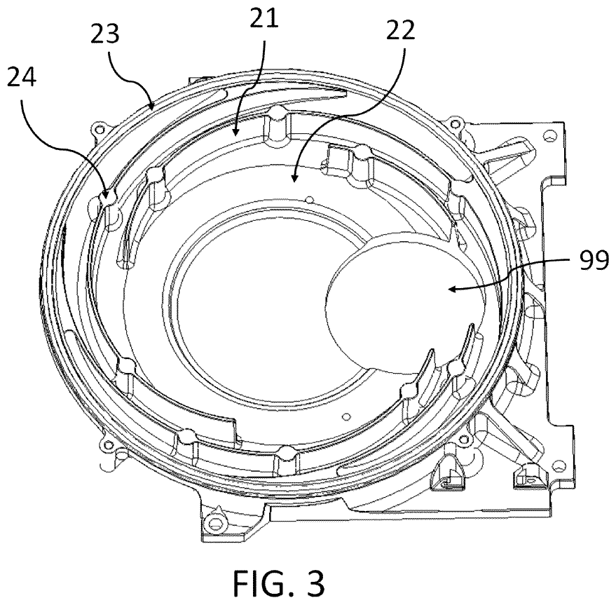

For further heat dissipation, the top portion 2 and the bottom portion 3 of the housing is further formed to include heat exchangers. FIG. 3 illustrates a perspective view of the top portion 2 of the housing of the laser reflection unit 1 according to some embodiment of the present disclosure. FIG. 4a illustrates a top view of the bottom portion 3 of the housing of the laser reflection unit 1 according to some embodiments of the present disclosure. FIG. 4b illustrates a bottom view of the bottom portion 3 of the housing of the laser reflection unit 1 according to some embodiments of the present disclosure.

The laser reflection unit 1 further comprises heat exchangers disposed in the top portion 2 of the housing for cooling and directing the air flow. The heat exchanger of the top portion 2 comprises at least one stationary vane 21 arranged around the central axis (A). When there is a plurality of stationary vanes 21, these are curved structures configured to form a pattern similar to an Archimedean spiral having multiple arms. The top portion 2 further comprises an outer rim 23 surrounding the lid 22. The inner surface of the outer rim 23 and the lid 22 are formed to have a curved surface used to direct the air flow within the housing. The at least one stationary vane 21 is further affixed to the lid 22 and the outer rim 23. The at least one stationary vane 21, the lid 22, and the outer rim 23 form a path to receive the air generated by the cooling fins 41. Preferably, the channels which are formed between two radially adjacent stationary vanes 21 have the same width. When there is only one stationary vane spirally arranged around the axis, the channel formed between the walls of the stationary vane preferably has a constant width.

In some embodiments, the channels formed by the walls of the at least one stationary vane 21, 31 are spiral channels. The laser reflection unit 1 further comprises heat exchangers disposed in the bottom portion 3 of the housing for cooling and redirecting the air flow. The heat exchanger of the bottom portion 3 comprises at least one stationary vane 31, illustrated for example in FIG. 4a. The at least one stationary vane 31 is/are curved structures configured to form a pattern similar to an Archimedean spiral having multiple arms. The bottom portion 3 comprises a base 33 and an outer rim 34 surrounding the base 33. The stationary vanes 31 are further affixed to the outer rim 34 and the base 33. The stationary vanes 31, the outer rim 34, and the base 33 form at least one channel to receive the air flow generated by the cooling fins 41 from the top portion 2. The air flow generated by the cooling fins 41 is received by the at least one channel formed by the stationary vanes 21 and directs the air flow towards the outer rim 23 of the top portion 2. The inner wall formed by the outer rim 23 then pushes the air flow towards the bottom portion 3. The channel formed by the stationary vanes 31, the outer rim 34, and the base 33 receives the air flow from the top portion 2 to form a path for the air flow towards the central part of the bottom potion 3. The at least one channel in the bottom portion 3 is spirally arranged such that the air flow exiting the channel flows in a rotating direction.

The top portion 2 and the bottom portion 2 of the housing may be coaxial with the wheel 4. Further, in some embodiments, the Archimedean spiral formed by the stationary vanes 31 and the stationary vanes 21 are coaxial with the cooling fins 41 of wheel 4.

The bottom portion 3 of the housing further comprises a cover 35 and fluid ports 32a, 32b arranged between the outer surface 33a of the base 33 and the cover 35. The fluid ports 32a, 32b may be coupled to a cooling system in the projector for dissipation of cooling fluid in the laser phosphor projector. In some embodiments, a space between the base 33 and the cover 35 form a compartment for receiving and circulating the cooling fluid. A plurality of protrusions 33b is further arranged on the outer surface 33a of the base 33. In an exemplary embodiment, as shown in FIG. 4b, the protrusions 33b are formed to be concentric annular protrusions. However, other forms of protrusions may be used to disturb the flow of the cooling fluid. In this way, the protrusions are configured to create turbulence in the flow of the cooling fluid and prevent the cooling fluid from taking the shortest path from one port to another. Thus, the cooling fluid can be evenly distributed to the area of the outer surface of the base.

Further, a seal 36 is preferably provided to fill the space between the outer surface 33a of the base 33 and the cover 35 to form a sealed compartment. In addition, a plurality of fastening elements 37 may be used to mechanically attach the base 33 and the cover 35. The fastening elements 37 may be screws or clamping elements.

The housing may be constructed from a heat conducting material. In some embodiments, the housing may be constructed from a metal, e.g., magnesium. Further, the rotating wheel 4 and the stationary vanes 21, 31 may also be made from any suitable material. In some embodiments, the rotating wheel 4 and the stationary vanes 21, 31 may be constructed from a metal, e.g., magnesium. In some embodiments, the top portion 2 and the bottom portion 3 are formed to have pins 24, 38 configured to protect the stationary vanes 21, 31 from deformation during manufacturing. The pins 24, 38 are configured to absorb force during demolding. Further, the pins 24, 38 may be strategically placed along the stationary vanes 21, 31 to induce turbulence as required and/or increase heat exchange in targeted regions.

In some embodiments, the configuration of the stationary vanes 31 and 21 allows the use of casting for shaping both the top portion 2 and the bottom portion 3. This eliminates the necessity for employing chemical (e.g., gluing) or thermal (e.g., soldering, brazing) bonding techniques to form the stationary vanes 21 and 31 respectively on the top portion 2 and the bottom portion 3. Moreover, as no additional assembly is required for forming the stationary vanes 21 and 31, the rims of the top portion 2 and the bottom portion 3 may be fashioned with a standard surface or shape, facilitating the use standard gaskets such as O-rings to create a sealed junction (or leak tight intersection) between the surfaces of the top portion 2 and the bottom portion 3.

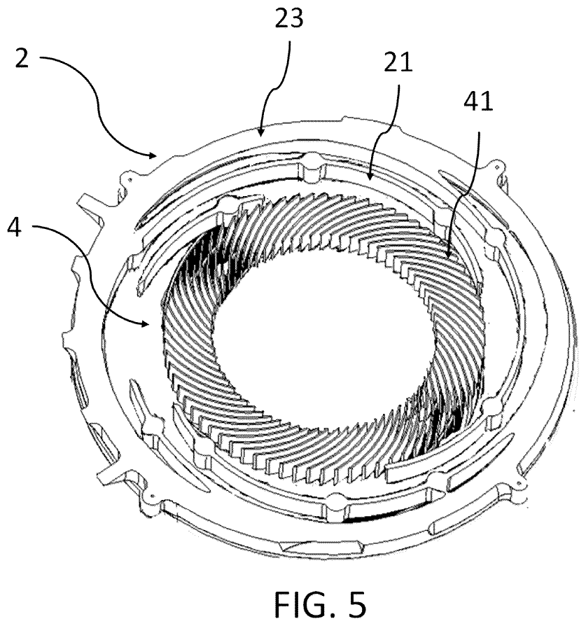

FIG. 5 illustrates a horizontal cross-sectional view of a top portion 2 of a housing and a wheel 4 of the laser reflection unit according to some embodiment of the present disclosure. The top portion 2 of the housing is arranged to be concentric with the wheel 4. The top portion 2 has a compartment to receive the wheel 4. The compartment is in a central portion of the top portion and is surrounded by the stationary vanes 21. The diameter of the wheel 4 is less than the diameter of the compartment in the top portion 2. As shown in FIG. 1, the at least one stationary vane 21 and the cooling fins 41 are arranged to be superposed on the at least one stationary vane 31. In some embodiments, the at least one stationary vane 21, 31 are respectively arranged in the top portion 2 and the bottom portion 3 such that the arrangement of the stationary vanes 21, 31 remains the same when the radial alignment between the top portion 2 and the bottom portion 3 shifts at an angle. In an exemplary embodiment, the angle at which the stationary vanes remain in a same arrangement (or the rotational symmetry between the two arrangements) is determined according to the greatest common divisor (GCD) between a number of the stationary vanes 21 of the top portion 2 and a number of the stationary vanes 31 of the bottom portion 3:
360°/(GCD(# fins in top plate, # fins in bottom plate))
   When eight stationary vanes are formed in the bottom portion and four stationary vanes are formed in the top portion, the angle is calculated as 360°/(GCD(8,4))=360°/4=90°. Thus, the shift in angle may be a multiple of 90 degree angle, which corresponds to a rotational symmetry of order 4.

Further, the number of stationary vanes 31 in the bottom portion 3 is preferably a multiple of the number of the stationary vanes 21 in the top portion 2. In some embodiments, the number of the stationary vanes 21 in the top portion 2 is, optionally, less than or equal to the number of stationary vanes 31 in the bottom portion 3. In an exemplary embodiment, when the number of stationary vanes 31 is 8, the number of the stationary vanes 21 may be 1, 2, 4, or 8. The number of stationary vanes 21, 31 is not limited thereto. The number of stationary vanes 21, 31 may be determined according to the specifications of the application and manufacturing limitation.

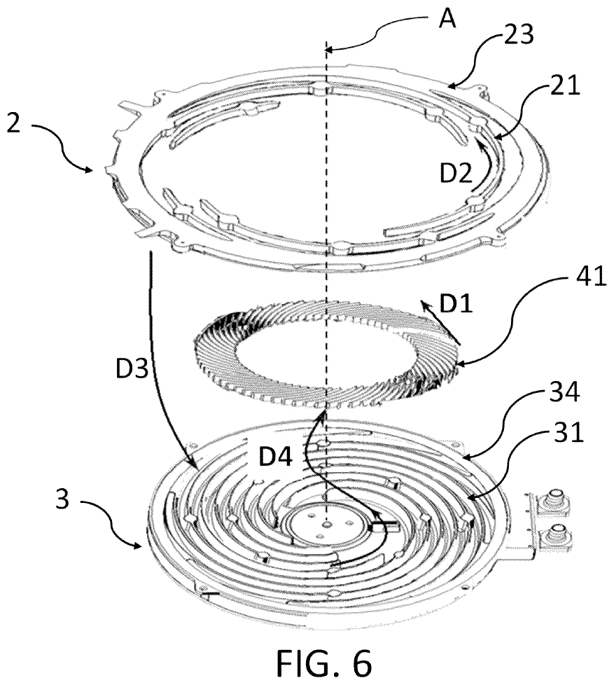

FIG. 6 shows a schematic exploded view of the laser reflection unit according to some embodiments of the present disclosure. The wheel 4 is arranged to have a same central axis A as the Archimedean spiral patterns formed by the stationary vanes 21, 31. By configuring the stationary vanes 21, 31 in Archimedean spiral pattern, the distance between neighboring stationary vanes 21, 31 remains the same along the air flow path. Consequently, this minimizes expansion or contraction within the flow path, thereby reducing kinetic energy loss of the airflow. When the top portion 2 and the bottom portion 3 are mechanically attached to each other during operation, lateral walls extending from the top portion 2 to the bottom portion 3 are formed. Preferably, the direction of the spiral rotation of the stationary vanes 31 in the bottom portion of the housing is opposite to the spiral rotation of the stationary vanes 21 in the upper portion of the housing. The stationary vanes 21, 31 in the housing are spirally arranged around the central axis, which creates a spiral path for the air flow generated by the cooling fins of the wheel 4. The spiral movement of the air flow helps to evenly distribute the cooling effect around the annular phosphor layer on the top side of the wheel.

The laser reflection unit 1 is configured to use a convective cooling system, wherein heat from the wheel is transferred to the airflow generated and subsequently cooled down by heat exchangers. The heated air flow generated by the wheel 4 is directed towards heat exchange surfaces, such as the stationary vanes 21, 31 before returning to the wheel 4 for further cooling. During the operation of the laser reflection unit 1, the wheel 4 is configured to rotate and induce an air flow. As illustrated in FIG. 6, the counter clockwise rotation of the wheel 4 produces an air flow traveling in a counter clockwise direction D1, tangential to the circumference of the wheel 4. The air flow then enters the channels or paths formed by the walls of stationary vanes 21 and/or the stationary vane 21 and the lateral walls formed along the outer rim 23 in the counter clockwise direction D2. The stationary vanes 21 of the top portion 2 are configured to receive from a same plane the air flow generated by the cooling fins 41 of the wheel upon rotation of the wheel 4. Upon reaching the lateral wall along the outer rim 23, the curved surface of the lateral walls along the outer rim 23 directs the air flow toward the bottom portion 3 of the housing. The air flow is further guided by the lateral wall along the outer rim 34 of the bottom portion 3 towards the centre of the bottom portion 3. The channels formed by the walls of the stationary vanes 31 direct the cooled air flow towards the center of the bottom portion 3. And, the air flow having a rotational flow is directed towards the wheel 4 as shown in direction D4. The rotating wheel 4 creates a low pressure, pulling the cooling air from the center of the bottom portion 3 upwards towards the central portion of the wheel 4. Further, the cooling air from the bottom portion 3 cools the cooling fins 41 and further facilitates cooling of the phosphor layer disposed above the cooling fins 41 by enabling the cooling fins 41 to continuously absorb heat from the phosphor layer and dissipating the heat through the air flow. The cooling fins 41, the stationary vanes 21, and 31, and the cooling fluid allow the air to cool, providing cooling air to the phosphor layer of the wheel 4. In other words, the air flow may be directed in the direction D4 due to the shape of the channel formed by the stationary vanes 31, the outer rim 34, and the base 33 for guiding the air flow towards the center of the bottom portion 3 while the rotation of the wheel 4 pulls the airflow upward. Thus, the direction D4 may be described as an air flow with a whirlwind direction. The combination of an outward Archimedean spiral with an inward Archimedean spiral of the stationary vanes 21, 31 helps preserve a significant portion of the angular momentum generated by the spinning wheel 4. As a result, this design minimizes drag on the wheel 4, potentially requiring less torque to maintain a consistent airflow within the laser reflection unit 1. Consequently, the torque supplied by the motor 5 can be maximized by increasing the rotation speed.

According to some embodiments of the present disclosure, the cooling fins 41 and the stationary vanes 21, 31 are configured to provide a maximum surface area to be in contact with the air flow within the housing and a maximum air path to increase the time for transferring the heat. The extended flow path length increases the contact of (and interaction between) the heated air molecules with the cooling surface (i. e the stationary vanes 21, 31). The path formed by the stationary vanes 21 to allow air flow towards the outer rim 23 of the top potion 2 has a length greater than the radial distance between the wheel 4 and the outer rim 23 of the top potion 2. In some embodiments, the path formed by the stationary vanes 31 to allow air flow towards the center of the bottom portion 3 has a length greater than the radius of the bottom portion 3 or the radial distance between the ends of the stationary vanes 31. The spiral configuration of the stationary vanes 21, 31 provides a long flow path for the air flow generated by the rotation of the wheel 4. The large heat exchange area formed by the long flow path and the high air flow velocity generated by the wheel 4 provides a lower thermal resistance for the laser reflection unit. Further, the stationary vanes 21, 31 generates air turbulence to increase collecting of heat. In this way, the heat threshold of the laser reflection unit 1 may be increased and further increase the maximum lumens of light that a projector can project.

The laser reflection unit uses a convective cooling system aimed at maximizing efficiency. Ideally, the cooling system achieves a lengthy air flow path per unit volume, maximizing contact area for heat exchange and heat transfer per unit area while minimizing air flow energy loss. When heat exchange surfaces are arranged radially, the airflow path length shall be limited to the planar radius of both the top and bottom portion of the laser reflection unit. Moreover, the width of the air flow path varies, expanding or contracting depending on the direction of the air flow towards the center of the laser reflection unit. By arranging the stationary vanes in an Archimedean spiral arrangement, the air flow path provided for heat exchange is greater than the planar radius of the top portion and the bottom portion of the laser reflection unit. The Archimedean spiral arrangement can provide a longer air flow path. Further, the longer flow path of the Archimedean spiral arrangement of stationary vanes can also provide a higher surface area for heat exchange. The Archimedean spiral arrangement of stationary vanes, having a length greater than the planar radius of the top portion and the bottom portion of the laser reflection unit, may provide a higher contact area. The stationary vanes in an Archimedean spiral arrangement provide an air flow path with constant width and with a low and gradual change in the path curvature. The Archimedean spiral configuration provides a consistent path width, reducing the loss of air molecules kinetic energy due to expansion and contraction in the width of the air flow paths and gentle flow direction change. In addition, due to the constant path width, the aero-acoustic noise that may be caused by expansion and contraction is also reduced or substantially eliminated. The low and gradual increase in the path curvature reduces tonal aero-acoustic noise peak intensity.

Accordingly, one aspect of the instant disclosure provides a laser reflection unit for a laser phosphor projector that comprises a housing having a top portion and a bottom portion mechanically fastened to the top portion, the top portion and the bottom portion correspondingly having stationary vanes provided on the inside wall of the housing, the stationary vanes being spirally arranged around a central axis of the laser reflection unit; the housing further having lateral walls extending from the top portion to the bottom portion and a wheel arranged within the housing and having a top side and a bottom side opposite the top side, the top side being provided with a phosphor layer arranged annularly on the top side for converting an incident laser light beam into a reflected light beam, the bottom side being provided with cooling fins, wherein the wheel is rotatably received in the top portion of the housing such that the cooling fins are arranged to be encompassed by the stationary vanes of the top portion and is configured to rotate around the central axis, and wherein the stationary vanes of the top portion are configured to receive from a same plane an air flow generated by the cooling fins of the wheel upon rotation of the wheel, and spirally guide the air flow outwards towards the lateral walls of the housing, and then downwards along the lateral walls towards the stationary vanes of the bottom portion, the stationary vanes of the bottom portion being configured to spirally guide the air flow inwards towards the centre of the bottom portion and upwards via the centre to the cooling fins of the wheel such that the airflow cools the phosphor layer.

In some embodiments, a number of the stationary vanes of the bottom portion of the housing is a multiple of a number of the stationary vanes of the top portion of the housing.

In some embodiments, a spiral direction of the stationary vanes of the bottom portion of the housing is opposite of a spiral direction of the stationary vanes of the top portion of the housing.

In some embodiments, channels between the stationary vanes are formed of a same width.

In some embodiments, channels formed by at least one stationary vane of the top portion have a same width.

In some embodiments, the bottom portion further comprises a base and an outer rim surrounding the base. The top portion further comprises a lid and an outer rim surrounding the lid. And, the stationary vanes of the top portion are affixed to the lid and the outer rim of the top portion, and the stationary vanes of the bottom portion are affixed to the base and the outer rim of the bottom portion.

In some embodiments, the laser reflection unit further comprises fluid ports between the base and a cover of the bottom portion to form a compartment for receiving cooling fluid. Protrusions are formed on an outer surface of the base to distribute the cooling fluid going throughout the outer surface and increase heat exchanging surface between the base and the cooling fluid within the compartment.

In some embodiments, the laser reflection unit further comprises a seal formed to fill a space between the outer surface of the base and the cover.

In some embodiments, the lid and the outer rim formed a curved surface configured to direct air flow from the top portion to the bottom portion of the housing.

In some embodiments, the cooling fins have backward curve arrangement, forward curve arrangement, or radial arrangement.

In some embodiments, the top side is perforated to form perforations 46 allowing air flow towards the top side of the wheel. And, a motor is configured to drive rotation of the wheel.

In some embodiments, pins are formed on the stationary vanes.

In some embodiments, the stationary vanes of the top portion and the bottom portion such the stationary vanes remain in a same arrangement when radial alignment between the top portion and the bottom portion shifts at an angle.

In some embodiments, the angle may be determined according to greatest common divisor (GCD) between a number of the stationary vanes of the top portion and a number of the stationary vanes of the bottom portion.

In some embodiments, the cooling fins is configured to adjust pressure and velocity of air circulating within the laser reflection unit.

In some embodiments, the top portion has a compartment on the central portion surrounded by the stationary vanes on the top portion to receive the wheel. The diameter of the wheel is less than the diameter of the compartment in the top portion.

Accordingly, another aspect of the instant disclosure provides a laser reflection unit of a laser phosphor projector that comprises a housing having a top portion and a bottom portion mechanically fastened to the top portion, the top portion and the bottom portion correspondingly having stationary vanes, the stationary vanes forming spiral channels; and a wheel disposed within the housing and configured to generate air flow in a direction tangential to the circumference of the wheel. The wheel has a phosphor layer arranged annularly on a top side of the wheel. The stationary vanes of the top portion form a compartment to receive the wheel. Air flow generated by the wheel flows within a path formed by the channels. The air flow from the channels of the stationary vanes of the bottom portion (3) is driven in rotational flow towards the wheel.

In some embodiments, the stationary vanes of the bottom portion forms a multiple arm Archimedean spiral pattern; and/or the stationary vanes of the top portion of the housing form a single arm or a multiple arm Archimedean spiral pattern.

In some embodiments, a number of the stationary vanes of the bottom portion of the housing is a multiple of a number of the stationary vanes of the top portion of the housing.

In some embodiments, a spiral direction of the stationary vanes of the bottom portion of the housing is opposite of a spiral direction of the stationary vanes of the top portion of the housing.

In some embodiments, the channels formed by the stationary vanes are formed of a same width.

In some embodiments, the cooling fins have backward curve arrangement, forward curve arrangement, or radial arrangement.

In some embodiments, the bottom portion further comprises a base and an outer rim surrounding the base; the top portion further comprises a lid and an outer rim surrounding the lid; and the stationary vanes of the top portion are affixed to the lid and the outer rim of the top portion and the stationary vanes of the bottom portion are affixed to the base and the outer rim of the bottom portion.

In some embodiments, the laser reflection unit further comprises fluid ports between the base and a cover of the bottom portion to form a compartment for receiving cooling fluid. Protrusions are formed on an outer surface of the base to distribute the cooling fluid going throughout the outer surface and increase heat exchanging surface between the base and the cooling fluid within the compartment.

In some embodiments, the laser reflection unit further comprises a seal formed to fill a space between the outer surface of the base and the cover.

In some embodiments, the lid and the outer rim form a curved surface configured to direct air flow from the top portion to the bottom portion of the housing.

In some embodiments, pins are formed on the stationary vanes.

In some embodiments, the top side is perforated to form perforations allowing air flow towards the top side of the wheel. And, a motor is configured to drive rotation of the wheel.

In some embodiments, stationary vanes of the top portion and the bottom portion are arranged such that the stationary vanes remain in a same arrangement when radial alignment between the top portion and the bottom portion shifts at an angle.

In some embodiments, the angle may be determined according to greatest common divisor (GCD) between a number of the stationary vanes of the top portion and a number of the stationary vanes of the bottom portion.

In some embodiments, the cooling fins is configured to adjust pressure and velocity of air circulating within the laser reflection unit.

In some embodiments, the top portion has a compartment on the central portion surrounded by the stationary vanes on the top portion to receive the wheel. The diameter of the wheel is less than the diameter of the compartment in the top portion.

Accordingly, another aspect of the instant disclosure provides a method of operating a laser reflection unit that comprises: rotating a wheel disposed within a housing, the housing having cooling fins configured to generate air flow during rotation; directing the air flow in a direction towards an outer rim of a top portion of the housing through at least one channel formed by at least one stationary vane of the top portion; directing the air flow in a direction towards channels formed the stationary vanes of the bottom portion; directing the air flow in a direction towards a center of the bottom portion through the channels formed the stationary vanes of the bottom portion; and directing the air flow in a direction towards a center of the wheel from the center of the bottom portion. A low pressure is generated between the cooling fins to drive the airflow back to the wheel.

In some embodiments, the air flow generated by the wheel are generated to flow in a direction tangential to the circumference of the wheel.

In some embodiments, the cooling fins have backward curve arrangement, forward curve arrangement, or radial arrangement.

In some embodiments, the method of operating a laser reflection unit further comprises directing the air flow towards a top side of the wheel through perforations.

In some embodiments, the method of operating a laser reflection unit further comprises fastening the top portion and the bottom portion to form a sealed compartment. The stationary vanes of the top portion and the bottom portion such the stationary vanes remain in a same arrangement when radial alignment between the top portion and the bottom portion during fastening shifts at an angle.

In some embodiments, the method of operating a laser reflection unit further comprises determining the angle according to greatest common divisor (GCD) between a number of the stationary vanes of the top portion and a number of the stationary vanes of the bottom portion.

In some embodiments, the stationary vanes of the bottom portion forms a multiple arm Archimedean spiral pattern; and/or the at least one stationary vane of the top portion of the housing form a single arm or a multiple arm Archimedean spiral pattern.

In some embodiments, a number of the stationary vanes of the bottom portion of the housing is a multiple of a number of the at least one stationary vane of the top portion of the housing.

In some embodiments, a spiral direction of the stationary vanes of the bottom portion of the housing is opposite of a spiral direction of the stationary vanes of the top portion of the housing.

In some embodiments, the channels formed by the stationary vanes are formed of a same width.

In some embodiments, the method of operating a laser reflection unit further comprises providing, by a fluid port, a cooling fluid between a base and a cover of the bottom portion; and agitating the cooling fluid using protrusions formed on an outer surface of the base to distribute the cooling fluid going throughout the outer surface and increase heat exchanging surface between the base and the cooling fluid within a compartment formed by the base and the cover.

In some embodiments, the cooling fins is configured to adjust pressure and velocity of the air flow circulating within the laser reflection unit.

While the invention has been described hereinabove with reference to specific embodiments, this was done to clarify and not to limit the invention. The skilled person will appreciate that various modifications and different combinations of disclosed features are possible without departing from the scope of the invention.

The following reference numbers are used throughout the text and Figures:
1—laser reflection unit
2—Top portion of the housing
21—Stationary vanes
22—Lid of the top portion
23—Outer rim of the top portion
24—Pins
3—Bottom portion of the housing
31—Stationary vanes
32a—Fluid ports
32b—Fluid ports
33—Base of the bottom portion
33a—Outer surface of the base
33b—Protrusions
34—Outer rim of the bottom portion
35—Cover of the bottom portion
36—Seal between the base and cover of the bottom portion
37—Fastening elements for attaching the base and cover of the bottom portion
38—Pins
4—Rotating wheel
41—Cooling fins
41a—Segmented cooling fins
41b—Airfoil-shaped cooling fins
42—Circular outer peripheral contour of the wheel
43—Top side of the wheel
44—Bottom side of the wheel
45—Phosphor layer on the top side of the wheel
46—Perforations
47—Radial central portion of the wheel
48—Radial intermediate annular portion of the wheel
49—Radial outer annular portion of the wheel
5—Motor
6—Machined plane surface
8—Power cable
99—Opening in the lid of the top portion for receiving an optical assembly
100—Fitting in the opening of the lid for receiving an optical assembly
101—First lens of the optical assembly
103—Second lens of the optical assembly
D1—Counterclockwise direction of air flow tangential to the circumference of the wheel (direction illustrated in FIG. 6)
D2—Counterclockwise direction of air flow through the channels formed by the walls of stationary vanes in the top portion (as the air flow travels from the wheel to the outer rim of the top portion)
D4—Direction of air flow generated by the rotation of the wheel, pulling cooling air from the center of the bottom portion upwards towards the central portion of the wheel (as the air flow is directed towards the wheel for further cooling)

1-44. (canceled)

45. A laser reflection unit for a laser phosphor projector, comprising:
a housing having a top portion and a bottom portion mechanically fastened to the top portion, the top portion and the bottom portion correspondingly having stationary vanes provided on the inside wall of the housing, the stationary vanes being spirally arranged around a central axis of the laser reflection unit, the housing further having lateral walls extending from the top portion to the bottom portion; and
a wheel arranged within the housing and having a top side and a bottom side opposite the top side, the top side being provided with a phosphor layer arranged annularly on the top side for converting an incident laser light beam into a reflected light beam, the bottom side being provided with cooling fins,
wherein the wheel is rotatably received in the top portion of the housing such that the cooling fins are arranged to be encompassed by the stationary vanes of the top portion and is configured to rotate around the central axis, and
wherein the stationary vanes of the top portion are configured to receive from a same plane an air flow generated by the cooling fins of the wheel upon rotation of the wheel, and the stationary vanes spirally guide the air flow outwards towards the lateral walls of the housing, and then the lateral walls guide the airflow downwards along the lateral walls towards the stationary vanes of the bottom portion, the stationary vanes of the bottom portion being configured to spirally guide the air flow inwards towards the centre of the bottom portion and upwards via the centre to the cooling fins of the wheel such that the airflow cools the phosphor layer.

46. The laser reflection unit of claim 45, wherein a number of the stationary vanes of the bottom portion of the housing is a multiple of a number of the stationary vanes of the top portion of the housing.

47. The laser reflection unit of claim 45, wherein a spiral direction of the stationary vanes of the bottom portion of the housing is opposite of a spiral direction of the stationary vanes of the top portion of the housing.

48. The laser reflection unit of claim 45, wherein channels between the stationary vanes are formed of a same width.

49. The laser reflection unit of claim 45, wherein channels formed by at least one stationary vane of the top portion have a same width.

50. The laser reflection unit of claim 45, wherein the top portion further comprises a lid and an outer rim surrounding the lid; the lid and the outer rim form a curved surface configured to direct air flow from the top portion to the bottom portion of the housing.

51. The laser reflection unit of claim 45, wherein:
the top side is perforated to form perforations allowing air flow towards the top side of the wheel; and a motor is configured to drive rotation of the wheel.

52. The laser reflection unit of claim 45, wherein pins are formed on the stationary vanes.

53. The laser reflection unit of claim 45, wherein the stationary vanes of the top portion and the bottom portion such the stationary vanes remains in a same arrangement when radial alignment between the top portion and the bottom portion shifts at an angle.

54. The laser reflection unit of claim 45, wherein the cooling fins is configured to adjust pressure and velocity of air circulating within the laser reflection unit.

55. The laser reflection unit of claim 45, wherein the top portion has a compartment on the central portion surrounded by the stationary vanes on the top portion to receive the wheel; the diameter of the wheel is less than the diameter of the compartment in the top portion.

56. A laser reflection unit for a laser phosphor projector, comprising:
a housing having a top portion and a bottom portion mechanically fastened to the top portion, the top portion and the bottom portion correspondingly having stationary vanes, the stationary vanes forming spiral channels; and
a wheel disposed within the housing and configured to generate air flow in a direction tangential to the circumference of the wheel, wherein:
the wheel having a phosphor layer arranged annularly on a top side of the wheel;
the stationary vanes of the top portion forming a compartment to receive the wheel;
air flow generated by the wheel flows within a path formed by the channels;
the air flow from the channels of the stationary vanes of the bottom portion is driven in rotational flow towards the wheel.

57. The laser reflection unit of claim 56, wherein:
the stationary vanes of the bottom portion forms a multiple arm Archimedean spiral pattern; and/or
the stationary vanes of the top portion of the housing form a single arm or a multiple arm Archimedean spiral pattern.

58. The laser reflection unit of claim 56, wherein a number of the stationary vanes of the bottom portion of the housing is a multiple of a number of the stationary vanes of the top portion of the housing.

59. The laser reflection unit of claim 56, wherein a spiral direction of the stationary vanes of the bottom portion of the housing is opposite of a spiral direction of the stationary vanes of the top portion of the housing.

60. The laser reflection unit of claim 56, wherein the channels formed by the stationary vanes are formed of a same width.

61. The laser reflection unit of claim 56, wherein the top portion further comprises a lid and an outer rim surrounding the lid; the lid and the outer rim form a curved surface configured to direct air flow from the top portion to the bottom portion of the housing.

62. The laser reflection unit of claim 56, wherein pins are formed on the stationary vanes.

63. The laser reflection unit of claim 56, wherein stationary vanes of the top portion and the bottom portion are arranged such that the stationary vanes remains in a same arrangement when radial alignment between the top portion and the bottom portion shifts at an angle.

64. The laser reflection unit of claim 56, wherein the top portion has a compartment on the central portion surrounded by the stationary vanes on the top portion to receive the wheel; the diameter of the wheel is less than the diameter of the compartment in the top portion.
